(19) United States
(12) Patent Application Publication
(10) Pub. No.: US 2025/0217421 A1
(43) Pub. Date: Jul. 3, 2025

(54) WEB CRAWLER SYSTEM THAT CRAWLS INTERNET ARTICLES AND PROVIDES A SUMMARY SERVICE OF ISSUE ARTICLE AFFECTING GLOBAL VALUE CHAIN

(71) Applicant: MIRAE CIT, Inc, Seoul (KR)

(72) Inventors: Wontae KIM, Seoul (KR); Dongkwon KIM, Seoul (KR); Nam Yong KANG, Seoul (KR); Kyoung Han BAE, Seoul (KR); Doo Hwan KIM, Yongin City (KR)

(73) Assignee: MIRAE CIT, Inc, Seoul (KR)

(21) Appl. No.: 18/941,763

(22) Filed: Nov. 8, 2024

(30) Foreign Application Priority Data
Nov. 14, 2023 (KR) 10-2023-0156844

(51) Int. Cl. G06F 16/951; G06F 40/284; G06F 40/289

(52) U.S. Cl. CPC G06F 16/951; G06F 40/284; G06F 40/289

(57) ABSTRACT

A web crawler system that crawls Internet articles and provides a summary service of issue articles affecting GVC includes a user terminal provided with a web agent that crawls and collects English issue articles of overseas media outlets, searches keywords, and displays a summary of overseas media issue articles; and an overseas issue article summary web crawler system that crawls English issue articles of the overseas media by the web agent to store multiple news article lists/articles classified by article titles in a DB, after sentence classification (SC) on the issue articles, selects sentences containing or related to key words of an item of interest in the issue articles, extracts words from each sentence, and provides a summary of overseas media issue articles that affect global value chain (GVC).

### CROSS-REFERENCE TO RELATED APPLICATION

This application claims priority to Korean Patent Application No. 10-2023-0156844, filed on Nov. 14, 2023, the disclosures of which is herein incorporated by reference in its entirety.

This invention was supported by a grant of Institutes for Information & Communication Technology Planning & evaluation of Ministry of Science and ICT (IITP, No. 2022-0-00302, Development of global demand forecasting and analysis/prediction system of market/industry trends.

### BACKGROUND OF THE INVENTION

### Field of the Invention

The present disclosure relates to a web crawler system that crawls and collects Internet articles and provides a summary service of issue articles affecting the global value chain (GVC), which crawls English issue articles from major global media including CNN USA, NYT (New York Times), WSJ (Wall Street Journal), Reuters UK and the like on the Internet to classify a news list and store a news article list/articles in a server DB, and then classifies sentences in an issue article (a sentence set, sentence 1, 2, 3, . . . ), selects sentences containing a title of the issue article, identifies the beginnings and ends of sentences using tokens in a sentence set including multiple sentences in an English issue article, extracts sentences, and extracts words in each sentence by utilizing a S/W engine that uses a key word combination algorithm of segmentation techniques of a language model (LM) of natural language processing (NLP) to search for keywords, analyze global economic trends in issue articles, and predict risks, and combines words reextracted according to English grammar, sentence structure, and word order, on the basis of the title of the issue article to provide a summary of major overseas issue articles that affect the global value chain (GVC).

### Description of the Related Art

A language model (LM) is a model processed by a computer by assigning probabilities to sentences (word sequences) or words to model language. Language modeling is a task of predicting words or sentences within a given task based on an existing dataset.

For example, if a word is w and a word sequence is an uppercase letter W, the probability of a word sequence W in which n words appear is expressed as follows:

$$P ( W ) = P ( {w}_{1} , {w}_{2} , {w}_{3} , {w}_{4} , {w}_{5} , … , {w}_{n} )$$

The probability of a next word appearing, when n-1 words are listed, as a conditional probability of an n-th word is expressed by the following equation.

$$P ( {w}_{n} \vert {w}_{1} , … {w}_{n - 1} )$$

For example, the probability of a fourth word is expressed as follows:

$$P ( {w}_{4} \vert {w}_{1} , {w}_{2} , {w}_{3} )$$

The probability of an entire word sequence W is known after all words have been predicted, and the probability of a word sequence is expressed as follows:

$$P ( W ) = P ( {w}_{1} , {w}_{2} , {w}_{3} , {w}_{4} , {w}_{5} , … , {w}_{n} ) = {\prod }_{i = 1}^{n} P ( {w}_{i} \vert {w}_{1 , … ,} {w}_{i - 1} )$$

Natural Language Processing (NLP) is a technology that allows a computer to understand the syntactic/semantic nature of human language through a natural language analysis. Natural language analysis is divided into four categories, such as a morphological analysis, a syntactic analysis, which divides a sentence with a series of strings expressed as a subject and a predicate into morphemes, which have the smallest units of meaning in the case of natural language, and analyzes the strings according to regular grammar, a semantic analysis, which analyzes the meaning (semantic) of a sentence, and a pragmatic analysis. In the field of NLP, an entire process of converting natural language used by humans into number vectors that computers can understand is called embedding.

A morpheme is the smallest unit of meaning (semantic) in the structure of words constructing a sentence, and is combined with a possessive case.

The syntactic analysis is classified into a top-down syntactic analysis and a bottom-up syntactic analysis. The syntactic analysis uses a syntactic analyzer that is handled by a parser included in an interpreter or compiler, and the parser is a program that performs a syntactic analysis by generating a structured syntax tree from a series of tokens, which are the results of lexical analysis. The top-down syntactic analysis is a method of reading a sentence from left to right, one character at a time, by a syntactic analyzer, and generating leaf nodes starting from the root node. Conversely, the bottom-up syntactic analysis is a method of generating a parse tree upward from the leaf nodes to the root node.

Recently, Google has developed bidirectional encoder representation from transformers (BERT), a learning-type natural language processing language model (LM), which is being utilized in the field of natural language processing (NLP). OpenAI and Microsoft Corporation have developed Chat-GPT, a conversational chatbot utilizing generative AI techniques, to provide language translation, database search, and question-answering services, and recently released GPT-4 Turbo.

Unlike an existing language model (LM) such as GPT, Google's BERT integrates bidirectional context based on an encoder of a transformer to express text, which is input data. In addition, a large corpus including sentences/words such as dictionaries and news that do not include labels is pre-trained, and the pre-trained model is fine-tuned by using a database that includes labels of downstream tasks and utilized in various downstream tasks. BERT simply recognizes the form of words or sentences. Recently, Google's AI service chatbot Bard was released.

Recently, OpenAI's GPT, ChatGPT, which is a natural language processing (NLP) language model (LM), was released, which provides language translation, text generation, and question-answering services using artificial intelligence. Generative Pre-trained Transformer 4 (GPT-4) is a multimodal large-scale language model that is pre-trained to predict a next token. Recently, OpenAI, the US developer of ChatGPT, released its latest artificial intelligence (AI) model, ‘GPT-4 Turbo’.

In Korea, the Voice Intelligence Research Group of the Electronics and Telecommunications Research Institute (ETRI) is researching word embedding technology based on Korean phoneme sequences, and Kookmin University is researching sentence generation techniques using a Korean phoneme-based LSTM language model.

In addition, the morphological analysis is a statistical and dictionary-based approach, and a morphological analysis system includes probability information learned from a corpus tagged with parts of speech and a separately pre-built vocabulary dictionary.

Most existing morphological analysis methods may use a word-based approach, and attach a part of speech to each individual word or morpheme.

Morphological analysis-based language models (LMs) use morphological analysis APIs to analyze the form and meaning of words and the structure and meaning (semantic) of sentences to understand the meaning of natural language sentences.

For example, BERT provides pre-training and fine tuning, and BERT, which is a pre-training method, pre-trains a large-scale language model that learns a large corpus by an upstream task that learns widely through a transformer, and then performs transfer learning through training a large-scale language model again. That is, it has a structure that applies a BERT language model to a large corpus and executes ‘good embedding’ values as an input for ‘transfer learning’ to an additional model.

BERT, which is a model trained by embedding a large corpus of 330 million words, and creates labels itself and performs self-supervised learning. BERT executes through an embedding process for a given sentence (a sequence of words), wherein an entire process of converting natural language into number vectors that computers can understand is called embedding, which is a general-purpose language model that expresses the meaning of words as vectors and shows good performance in the field of NLP.

Embedding typically plays the following three roles:
1) Calculation of correlation between words/sentences
2) Implication of semantic/grammatical information between words (word analogy assessment)
3) Transfer learning (using good embeddings as input values for deep learning models)

Large corpus→BERT→(data to be classified)→machine learning model such as LSTM, CNN→classification

### (1) Upstream Task

An upstream task means learning widely. The upstream task pre-trains a large corpus. Learning methods include learning relationships between sentences to predict a next word (sentence) that will come after a certain word (Next Sentence Prediction, NSP), and putting a blank space in a word and then guessing the blank space (Masked Language Model, MLM). A BERT model performs an upstream task (pre-training) using both methods, and GPT performs an upstream task using only the NSP method.

### (2) Downstream Task

It learns widely through pre-training by an upstream task, and then learns deeply through transfer learning by a downstream task. Multiple tasks may be generated.
Sentence classification (SC): It is a task that returns a probability value of positive, negative, or neutral for a sentence.
Natural Language Inference (NLI): It is a task that returns a probability value of true, false, or neutral for a sentence.
Named Entity Recognition (NER): It is a task that returns a probability value of a name of entity, such as a name of organization, a name of person, or a name of place.
Question Answering (QA): When a question is given, it is a task that returns a probability value for an answer (it is a task that returns a probability value of a beginning+an end of a correct answer for each word).
Sentence Generation (SG): It is a task that receives a sentence and returns a probability value for an entire vocabulary.

### (3) Tuning

### (3.1) Fine-Tuning

It is characterized by using an entire downstream task data, and updating an entire model. There is a disadvantage in that the larger the language model (LM), the higher the computational cost required to update the entire language model. Due to the above disadvantage, prompt tuning and in-context learning are used.

### (3.2) Prompt Tuning

It means that a model is partially updated using entire downstream task data.

### (3.3) In-Context Learning

In-context learning is a method of performing a downstream task without updating a model by means of a method of using only a partial portion of downstream task data. In-context learning is classified into zero-shot learning, one-shot learning, and few-shot learning.

### (3) Tokenization

Tokenization means dividing a sentence into smaller units. In order to input into a natural language processing model such as BERT and GPT, a tokenization procedure is preferentially required. A tokenization method uses a word-level, a character-level, and a subword-level.

### 1) Word-Level Tokenization

Tokenization is performed at a word-level. For example, the sentence “ [symbol] [symbol] [symbol] [symbol] [symbol] [symbol] [symbol] [symbol] (I went to café yesterday)” is divided into “ [symbol] (I)”, “ [symbol] [symbol] (went)”, “ [symbol] [symbol] (cafe) “, and “ [symbol] (yesterday)”. It has a disadvantage in that a size of lexical set may increase because of taking into consideration as many words as possible, and as it increases, model training becomes difficult.

### 2) Character-Level Tokenization

Tokenization is performed on a character-by-character basis. The character units represent a, b, c, d/ [symbol] . The advantage of character-level tokenization may include all the characters of the language, but there is a disadvantage in that each character token is difficult to be a meaningful unit. For example, the distinction between the character “ [symbol] ” in “ [symbol] [symbol] ” and the character “ [symbol] ” in “ [symbol] [symbol] ” disappears, and because a length of the token sequence becomes longer, there is a disadvantage in that learning performance deteriorates. For example, “ [symbol] [symbol] [symbol] [symbol] [symbol] [symbol] [symbol] ”→ is converted to [symbol] , [symbol] , [symbol] , [symbol] , [symbol] , [symbol] , and [symbol] , and the token sequence becomes longer.

### 3) Subword-Level Tokenization

As an intermediate form of word-level tokenization and character-level tokenization, subword-level tokenization is characterized by not having an excessively large vocabulary size, solving the problem of unregistered tokens, and ensuring that token sequences are not too long. A representative implementation example is Byte Pair Encoding (BPE).

As prior art 1 related thereto, Korean Patent Publication No. 10-2023-0047849 discloses “METHOD AND SYSTEM FOR SUMMARIZING DOCUMENT USING HYPERSCALE LANGUAGE MODEL.”

A document summary system including:
a communication module; a memory; and at least one processor connected to the memory configured to execute at least one computer-readable program stored in the memory,
wherein the at least one program is configured to:
receive a document containing a first sentence set,
input the first sentence set into a category analyzer to extract a second sentence set belonging to a first category, wherein the second sentence set is a subset of the first sentence set,
cluster the second sentence set belonging to the first category into a first cluster set,
extract a third sentence set from the first cluster set, wherein the third sentence set is a subset of the second sentence set, and
include commands for inputting the third sentence set to a language model and generating a first summary sentence associated with the first category of the document.

Recently, there has been an active development and operation of programs in which stock market and economic analysis experts conduct various economic analyses, develop content predicting economic crises and opportunities, transmit them to customers through YouTube, and widely use a program having a conversation with them. In those programs, world-renowned analysts and economic experts appear and engage in conversations with the host, using current economic issues and difficult economic models to provide persuasive explanations through direct demonstrations to clients. Additionally, corporate clients who manage the global value chain (GVC) also engage in question-answering conversations by asking questions in the comment section and receiving expert opinions on those questions.

These economic programs have received even greater support due to the COVID-19 pandemic that has swept the world, and have also been a great help in securing global responsiveness for companies through economic policy responses and estimates of changes in the global supply chain according to daily disease outbreaks and changes in response situations. In particular, for export-oriented South Korea, the COVID-19 pandemic has taught that GVC issues are very important information even for small and medium-sized enterprises, and securing confrontation ability based thereon is a source of corporate competitiveness.

However, despite the fact that economic experts are developing a large amount of economic content, companies and economic research institutes are unable to obtain clear, customized answers in the areas they need. In particular, although they quickly identify changes in their fields of interest and related fields, analyze them precisely, and take actions accordingly, they do not have the ability to handle the enormous flood of information pouring in real time through the Internet and do not have the ability to analyze big data using the information.

Recently, not only long-term predictions and actions regarding the economic impact of the successive announcements and ramifications of inflation and environmental policies by governments around the world, such as the Inflation Reduction Act (IRA) legislation in the United States, climate crisis action, and carbon neutrality actions, but also short-term and ultra-short-term predictions and responses have come to determine the rise and fall of companies and the national economy. Therefore, decision makers and executives who manage the company's global value chain (GVC) need a compass to read their direction under the flood of Internet information, and clients who manage companies want to secure customized economic information that is fast, accurate, and easy to understand by analyzing big data of the Internet pouring out in real time.

The background technologies that provide those services typically require technologies such as securing and storing Internet documents, natural language processing (NLP) to read articles, and text mining to extract information from articles. Furthermore, text mining includes text analysis technology that preprocesses and identifies sentences.

In addition, existing web crawler systems have simply provided only website crawling, but have not provided summary services for issue articles of overseas media that affect the global value chain (GVC) from an economic perspective.

(Patent Document 1) Korean Patent Publication No. 10-2023-0047849 (Publication Date: Apr. 10, 2023), “METHOD AND SYSTEM FOR SUMMARIZING DOCUMENT USING HYPERSCALE LANGUAGE MODEL”, Naver Corporation

### SUMMARY OF THE INVENTION

In order to solve the above-described problems, an aspect of the present disclosure is to provide a web crawler system that crawls and collects Internet articles and provides a summary service of issue articles affecting the global value chain, which crawls English issue articles from major global media including CNN USA, NYT (New York Times), WSJ (Wall Street Journal), Reuters UK and the like on the Internet to classify a list of news articles by article title and store the article list/articles in a server DB, and then classifies sentences in an issue article (a sentence set, sentence 1, 2, 3, . . . ), selects sentences containing key words of an item of interest including a title of the issue article with a priority, selects sentences related to the key words of the item of interest (positive/negative) by natural language inference (NLI) for the remaining sentences, identifies the beginnings and ends of sentences using tokens in each of the selected sentences, and extracts key words in each sentence by utilizing a S/W engine that uses a key word combination algorithm of segmentation techniques of a language model (LM) of natural language processing (NLP) to search for keywords, analyze global economic trends in issue articles, and predict risks, and combines words reextracted by English grammar, sentence structure, and word order, on the basis of the title of the issue article to generate summary sentences and provide summary information on major overseas issue articles that affect the global value chain (GVC) centered on overseas media issue articles.

In order to achieve an aspect of the present disclosure, a web crawler system that crawls Internet articles and provides a summary service of issue articles affecting the global value chain includes a user terminal provided with a web agent that crawls and collects English issue articles of overseas media, searches keywords, and displays a summary of overseas media issue articles; and an overseas issue article summary web crawler system that crawls English issue articles of the overseas media by the web agent to store multiple news article lists/articles classified by article titles in a DB, and then searches for keywords, performs sentence classification (SC) on the issue articles, selects sentences containing key words of an item of interest in the issue articles, extracts words from each sentence, and provides a summary of overseas media issue articles that affect the global value chain (GVC) using a key word combination algorithm of segmentation techniques for each sentence according to English grammar, sentence format, and word order.

A web crawler system that crawls and collects Internet articles and provides a summary service of issue articles affecting the global value chain (GVC) in the present disclosure may crawl English issue articles from major global media including CNN USA, NYT (New York Times), WSJ (Wall Street Journal), Reuters UK, and the like on the Internet to classify news by an item of interest, store the article list/articles in a server DB, and then extract key words using a key word combination algorithm of segmentation techniques of phrases/clauses/words of English sentences in a language model (LM), provide a summary of major issue articles in overseas media that affect the global value chain (GVC), on the basis of English articles of overseas media, and monitor Internet articles provided by overseas media outlets to analyze global economic trends in issue articles and provide a summary service of major overseas issue articles based on economic analysis in connection with key incidents in Internet articles so as to allow government agencies, companies, and economic analysis organizations that need to predict risks to quickly discover and easily understand the key incidents in major issue articles that affect the global value chain (GVC) and corporate competitiveness.

The overseas issue article summary web crawler system may crawl English issue articles of overseas media on the Internet and store them in a server DB to detect and preemptively respond to risks in the global supply chain or global value chain (GVC) of issue articles from an economic perspective, and then monitor issue articles containing various incidents occurring in the global value chain (GVC) and global supply chain required by clients in real time, extract key word information related to an item of interest from issue articles of overseas media, summarize the issue articles to provide a framework to provide an overseas media issue article summary service. In addition, this framework is configured to provide both a summary service of overseas media issue articles and an on-premise service using cloud computing. In a current situation where incidents and accidents are frequent in each country around the world and have a significant impact on the global value chain (GVC) and global supply chain, it will be a very useful solution for economic organizations that need to predict risks in the global value chain (GVC), provide economic outlook to companies and customers who need to respond preemptively, and make decisions.

### BRIEF DESCRIPTION OF THE DRAWINGS

FIG. 1 shows a web crawler architecture.

FIG. 2 is a configuration diagram of a web crawler system that crawls and collects Internet articles and provides a summary service of issue articles affecting the global value chain, in which it is shown a data processing process that provides a summary of major issue articles in overseas media in the web crawler system in a cloud computing environment of the present disclosure.

FIG. 3 is a diagram showing an issue and key factor screen including dates of overseas media site, GVC categories, “items of interest and regions of interest”, “issue articles discovery”, and “key sentence derivation and summary” from overseas media sites in FIG. 2.

FIG. 4 is a diagram showing a case of “GVC incident monitoring and trend analysis” in FIG. 2.

FIG. 5 shows a crawling module written in a Python script format.

FIG. 6 is a screen for deriving issues and key factors.

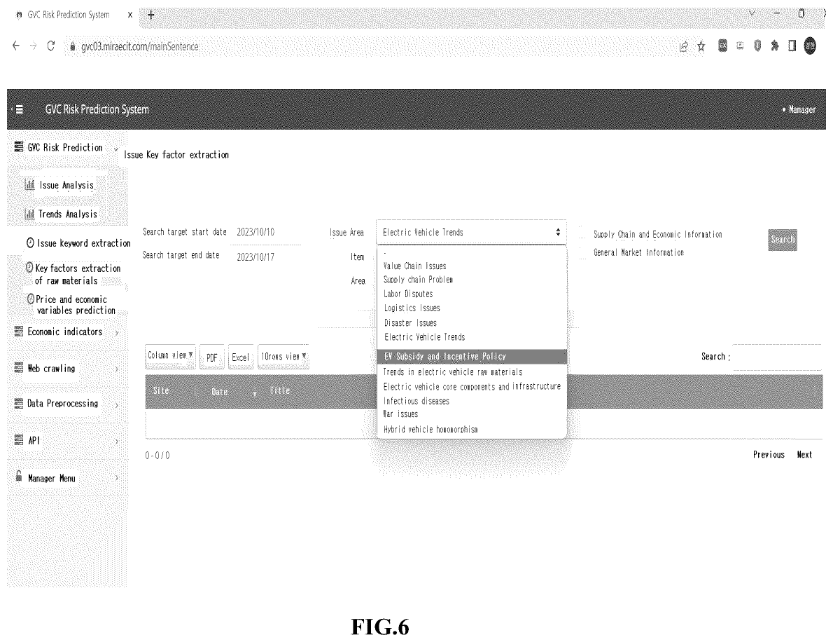

FIG. 7 is a screen showing titles and key summary information of articles by date in overseas media.

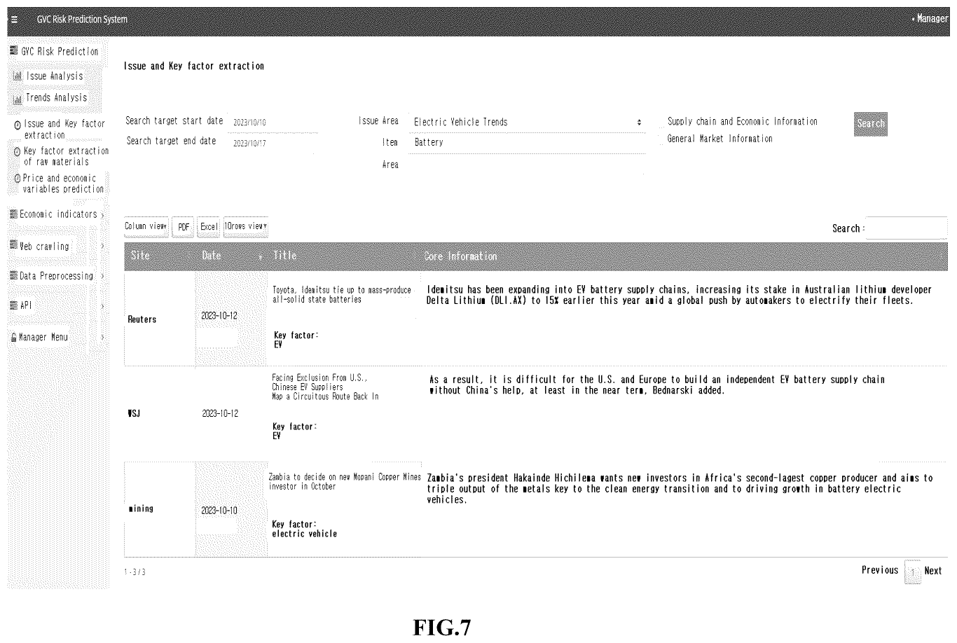

### DETAILED DESCRIPTION OF THE INVENTION

Hereinafter, the configuration and operation of preferred embodiments of the present disclosure will be described in detail with reference to the accompanying drawings.

The present disclosure may not be limited to the disclosed embodiments and implemented in various different forms by those skilled in the art. In describing the present disclosure, a detailed description thereof will be omitted when it is determined that a specific description publicly known technologies or configurations related thereto may unnecessarily obscure the subject matter of the present disclosure. Additionally, in the accompanying drawings, reference numbers are given to the same reference numbers in other drawings when indicating the same element.

However, it should be understood that the present disclosure is not limited to specific embodiments, but includes all modifications, equivalents, or substitutes included in the concept and technical scope of the present disclosure.

A web crawler system that crawls and collects Internet articles and provides a summary service of issue articles affecting the global value chain (GVC) crawls English issue articles from major global media including CNN USA, NYT (New York Times), WSJ (Wall Street Journal), Reuters UK and the like on the Internet to classify news by article title and store the article list/articles in a server DB, and then performs sentence classification (SC, a sentence set, sentence 1, 2, 3, . . . ) on English issue articles, and then selects sentences containing key words of an item of interest from the sentence set with a priority, selects sentences related to the key words of the item of interest (positive/negative) by natural language inference (NLI) for the remaining sentences, identifies the beginnings and ends of sentences using tokens in each of the selected sentences, and extracts words in each sentence by utilizing a S/W engine that uses a key word combination algorithm of segmentation techniques of a language model (LM) of natural language processing (NLP) to search for keywords, analyze global economic trends in issue articles, and predict risks, and combines words reextracted based on English grammar, sentence structure, and word order on the basis of the title of the issue article to generate summary sentences and provide a summary of issue articles from overseas media that affect the global supply chain and global value chain (GVC) centered on issue articles in overseas media, centered on issue articles in overseas media from an economic perspective.

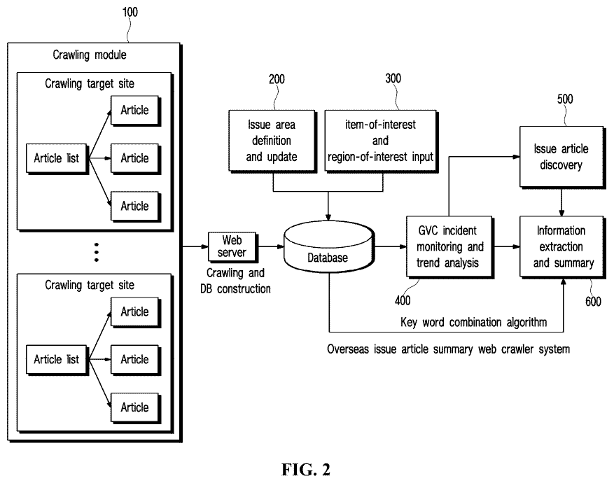

FIG. 2 is a configuration diagram of a web crawler system that crawls and collects Internet articles and provides a summary service of issue articles affecting the global value chain, in which it is shown a data processing process that provides a summary of issue articles in overseas major media in the web crawler system in a cloud computing environment according to an embodiment of the present disclosure.

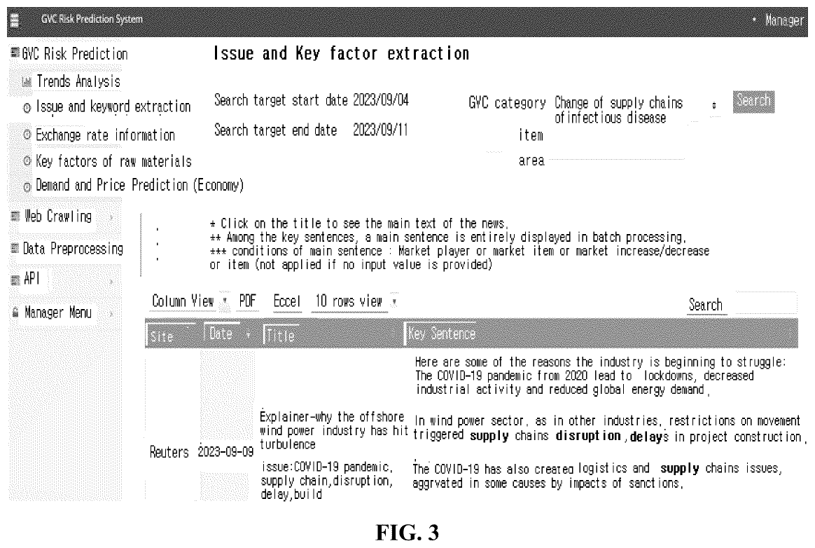

FIG. 3 is a diagram showing an issue and key factor screen including dates of overseas media site, GVC categories, “items of interest and regions of interest”, “issue articles discovered”, and “key sentence derivation and summary” from overseas media sites in FIG. 2.

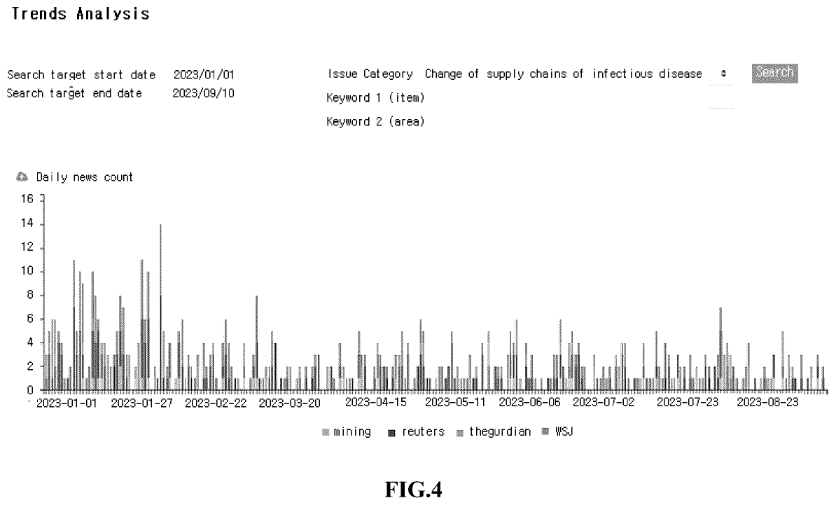

FIG. 4 is a diagram showing a case of “GVC incident monitoring and trend analysis” in FIG. 2.

An overseas issue article summary web crawler system having a data processing process of providing a summary of major issue articles from major overseas media outlets includes a crawling module 100, an issue area definition and update module 200, an item-of-interest and region-of-interest input module 300, a GVC incident monitoring and trend analysis module 400, an issue article discovery module 500, and an information extraction and summary module 600.

### * Summary Service of Major Overseas Issue Articles

Web crawling technology for issue articles of overseas media: HTTP-based Open API is used
Language intelligence, natural language processing (NLP) language model (LM): A summary of an article list/news issue articles classified by category of an item of interest from overseas media outlets using a BERT or GPT-4 algorithm is provided (English text)
News article list/article web crawling classified by category based on item of interest
Web-crawled article list/articles, summary of issue articles: Sentence classification (SC) of issue articles using a BERT or GPT-4 algorithm, and key word sentences of an item of interest are selected with priorities (word-level recognition)
A relationship between the remaining sentences that are not selected with priorities is decided by using a natural language inference (NLI) model to determine whether it is positive (sentence selection) or negative (false, discard).
The beginnings and ends of sentences are distinguished by using tokens tokenization/pre-processing artifacts
Segmentation technique of phrases/clauses/words in English sentences and key word combination algorithm
1) Sentence classification (SC): Multiple sentence sets of issue articles,
Sentences containing key words of an item of interest in the issue article are selected with priorities (word-level recognition)
Determine whether to select the remaining sentences by natural language inference (NLI), that is, decide a relationship between the remaining sentences that are not selected with priorities to determine whether it is positive (sentence selection) or negative (false, discard).
2) Sentences containing key words of item of interest and selected sentences: Extract words from sentences Long and unnecessary sentences without key words of an item of interest are removed, phrases/clauses may be omitted.
3) Segmentation technique of phrases/clauses/words and key word combination algorithm: Sentences are combined again according to English grammar, sentence structure, and word order
4) Generation of summary sentences of overseas media issue articles

The web crawling system, for example, when using a BERT algorithm or GPT-4 algorithm, performs sentence classification (SC, sentence 1, 2, 3, . . . ) on issue articles for each article list/articles classified by category of an item of interest such as COVID-19, exchange rate, stock price, war, earthquake and the like for the issue articles, and then selects sentences containing/relating to key words of the item of interest in the issue articles with priorities, selects sentences related to the key words of the item of interest (positive/negative) by natural language inference (NLI) for the remaining sentences, extracts sentences from issue articles using tokens that indicate the beginnings and ends of the respective selected sentences, identifies the beginnings and ends of respective sentences using tokens in a sentence set including multiple sentences from the issue articles, extracts words from each sentence, combines the extracted words again using a key word combination algorithm using a segmentation technique of English sentences into phrases/clauses/words according to English grammar, sentence format, and word order, and a key word combination algorithm to generate and provide a summary of issue articles.

A web crawler system that crawls and collects Internet articles and provides a summary service of issue articles affecting the global value chain (GVC) according to the present disclosure may include:
a user terminal provided with a web agent that crawls and collects English issue articles of overseas media, searches keywords in overseas issue articles, and displays a summary of overseas media issue articles; and
an overseas issue article summary web crawler system connected to the user terminal provided with the web agent through a wired/wireless communication network to crawl English issue articles of overseas media by the web agent to classify a list of articles by article tile and store multiple news article list/articles in a DB, and then provides a keyword search result, performs sentence classification (SC, a sentence set) on the English issue articles, and then selects sentences containing key words of an item of interest in the issue article with priorities by utilizing a S/W engine of a server that uses a key word combination algorithm of segmentation techniques of a language model (LM) of natural language processing (NLP) to analyze global economic trends and predict risks in overseas media issue articles, selects sentences related to the key words of the item of interest (positive/negative) by natural language inference (NLI) for the remaining sentences, identifies the beginnings and ends of sentences using tokens in each of the selected sentences and extracts sentences, extracts key words in each of the selected sentences, combines words extracted again based on English grammar, sentence structure, and word order centered on the title of the issue article to generate a summary issue articles and provides a summary of issue articles of overseas media that affect the global value chain (GVC) centered on English articles of the overseas media.

The sentences in the issue articles are recognized at a “word-level.”

Sentence classification (SC) is performed on issue articles using BERT, and then words in sentences containing the selected key words of the item of interest are extracted, and then a summary of the issue articles is provided by using a key word combination algorithm of segmentation techniques.

For example, the key word combination algorithm of segmentation techniques uses a bidirectional encoder representation from a transformer (BERT) algorithm or generative pretrained transformer-4 (GPT-4) algorithm as a language model (LM) of natural language processing (NLP) to extract a summary of English issue articles in overseas media, and subsequent to sentence classification (SC) of the issue articles, selects sentences containing an item of interest (key words), removes the remaining sentences, and uses a segmentation technique of phrases/clauses/words of the selected English sentences and a key word combination algorithm.

For reference, Google BERT represents text, which is input data, by integrating bidirectional context based on an encoder of transformer. In addition, a a large corpus including sentences/words of news (issue articles) that do not include labels is pre-trained, and the pre-trained model is fine-tuned by using a database that includes labels of downstream tasks and utilized in various downstream tasks. BERT simply recognizes the form of words or sentences.

A BERT-based natural language processing model receives a large corpus to use a tokenizers library to which the WordPiece tokenization technique is applied.

### * Text Dataset and Tokenizers

Tokenizers prioritize words based on statistical values, build a vocabulary, and parse text into tokens.

TABLE 1

| token | token-id | Description |
|---|---|---|
| <pad> | 0 | A short sentence is padded with <pad> to match a length of |
| | | a long sentence to handle sentences of different lengths |
| <unk> | 1 | When a tokenizer encounters an unknown word, a processing |
| | | token is used to treat it as unknown |
| <s> | 2 | A token that indicates a beginning of a sentence, also used |
| | | as a begin of sentence (BOS), classification (CLS) token |
| </s> | 3 | A token that indicates an end of a sentence, also used as |
| | | an end of sentence (EOS), separator (SEP) token |
| <mask> | 4 | A token used in training a masked language model (MLM), |
| | | used to solve a problem of matching a token by masking the |
| | | token |

In addition, a generative pre-trained transformer (GPT) is a natural language processing (NLP) language model (LM), which is available as GPT-3, GPT-3.5, or GPT-4 to summarize issue articles, and provides language translation, text generation, summarization, and question-answering services using artificial intelligence. GPT-4 is a multimodal large-scale language model that is pre-trained to predict a next token.

The GPT-4 API is a generative AI technology that provides a text summary of token-based sentences in issue articles for a GPT-based large-scale language model (LLM). GPT-4 may reinterpret any kind of text document and write a summary of issue articles on its own.

The user terminal uses a computer, laptop computer, or smartphone/tablet PC.

The web agent may include a crawling module implemented as a plug-in program in a web browser to crawl issue articles from the overseas media, classify a news list according to article titles, and store an article list/articles of the issue articles in a server DB of the overseas issue article summary web crawler;
a keyword search module that selects registered overseas media outlets and searches for English issue articles in overseas media outlets using an issue identification keyword, an item-of-interest keyword, and a region-of-interest keyword; and
an issue article summary display module that performs sentence classification (SC, multiple sentence sets) constructing English issue articles from overseas media outlets using a public API of a BERT algorithm or GPT-4 algorithm on the server, and then selects sentences containing key words of an item of interest from a sentence set including a large number of sentences in English issue articles, selects sentences related to the key words of the item of interest (positive/negative) by natural language inference (NLI) for the remaining sentences, identifies the beginnings and ends of the sentences using tokens in each sentence and extract sentences, extracts words from each sentence, and combines the extracted words again using a segmentation technique of phrases/clauses/words in English sentences according to English grammar, sentence format, and word order on the basis of titles of overseas media issue articles and a key word combination algorithm to generate a summary of issue articles and store it in a server DB, and then provides a summary of overseas media issue articles. When summarizing, words, adjectives and adverbs are used as they are.

Additionally, the web agent further includes a chat module that transmits and receives chat data between a journalist and a site operator via a chat server. In this case, the overseas issue article summary web crawler system further includes a chat server.

An AI summary result of overseas media issue articles is displayed by news list classified by category of an item of interest and a region of interest on overseas media websites, and the summary result of overseas media issue articles is automatically generated at set intervals and displayed on the screen.

The overseas issue article summary web crawler system may include:
a web server and a database;
an issue area definition and update module 200 that performs, when various types of issues such as an infectious disease, a war, and a disaster occur, generation and upgrade of an issue area, and keyword addition and upgrade, wherein a keyword is used to define an issue area, and the keyword defining the issue area includes an issue identification keyword, a field-of-interest identification keyword, and a field-of-interest change keyword;
an item-of-interest and region-of interest input module 300 that selects an issue area with GVC, the power receives an item of interest and a region of interest;
a GVC incident monitoring and trend analysis module 400 that is implemented by calculating a number of issue-related keywords and expressing figures in a graph, and monitors a GVC incident, analyzes a trend, and displays them on a screen of the user terminal;
an issue article discovery module 500 that performs a role of finding issue articles containing a step-by-step keyword; and
an issue article information extraction and summary module 600 that extracts GVC information from the issue articles discovered by the issue article discovery module 500, summarizes the extracted issue articles, and specifically, performs sentence classification (SC, multiple sentence sets) constructing English issue articles of overseas media using a BERT or GPT-4 algorithm on the server, and then identifies the beginnings and ends of sentences using tokens in each sentence in a sentence set including multiple sentences of English issue articles and extracts sentences, extracts words (words of interest) from each sentence, and combines the extracted words again, extracts the words again and generates a summary of issue articles and stores it in the server DB using a technique for segmenting English sentence phrases/clauses/words based on English grammar, sentence format, and word order and a key word combination algorithm, and then provides a summary of the overseas media issue article transmitted from the server.

In the issue article discovery module 500, the step-by-step keyword includes an issue identification keyword, a field-of-interest identification keyword, and a field-of-interest change keyword, and articles including the issue identification keyword are extracted in a first step, and articles including the field-of-interest identification keyword are extracted from the articles selected in the first step in a second step. Articles including the field-of-interest change keyword are extracted from the articles extracted in the first and second steps in a third step.

The issue article information extraction and summary module 600 of the overseas issue article summary web crawler system crawls the English issue articles of the overseas media by the web agent of the user terminal to store multiple news lists/news classified by article titles in a DB, and then classifies sentences (sentence set), selects sentences containing key words of an item of interest from the sentence set including multiple sentences of the English issue articles, selects sentences containing the key words of the item of interest (positive/negative) by natural language inference (NLI) for the remaining sentences, identifies the beginnings and the ends of sentences using tokens in the selected sentences to extract sentences, and extracts words of each sentence, and combines the words extracted again according to English grammar, sentence format, and word order on the basis of the titles of overseas media English issue articles using a key word combination algorithm of segmentation techniques of phrases/clauses/words of a language model (LM) to generate summary sentences and provide a summary of major overseas issue articles affecting the global value chain (GVC).

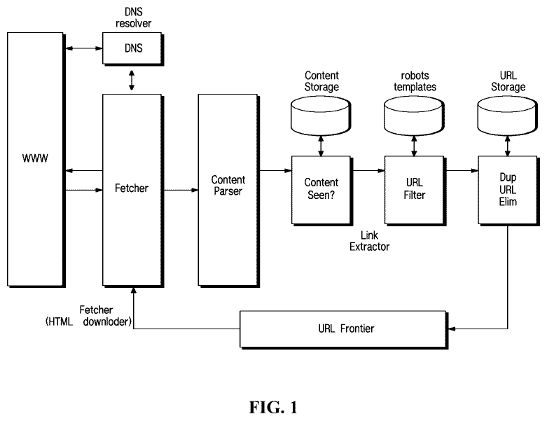

Referring to FIG. 1, an internal configuration diagram of the crawling module is shown. The crawling module is a web crawler programmed in Python.

Crawling, which is a process of collecting content existing on a website (collecting through automated programming), is a technique of downloading HTML pages, storing them in a content storage, parsing HTML/CSS, and extracting only necessary data from the visited URL.

In an embodiment, the crawling module created a crawler in Python, and used a technique to extract only the necessary data from the received data by calling an open API to a service providing the REST API.

Additionally, a technique of programming by using a browser such as Selenium to extract only the necessary data may be extracted.

A web crawler is a program that uses an automated program to explore the World Wide Web (WWW), and automatically downloads html data from a website screen and stores it in a content storage.

Upon receiving seed URLs to start crawling, the web crawler first finds URLs related to a URL frontier, finds another hyperlink from the URLs, and when the URL frontier first passes a URL to be explored to a fetcher, which has an HTML downloader, the fetcher downloads the HTML content of the webpage by means of the HTML downloader, stores the downloaded HTML content in the content storage, passes it to a content parser, and finds other hyperlinks. The contents parser parses the downloaded html web page.

In this process, upon receiving a seed URL to start crawling, the web crawler finds related URLs, finds other another hyperlink from those URLs, and continues to repeat this process by means of a DNS resolver (domain name converter), and downloads the HTMLs of the hyperlinks through an HTML downloader and stores the downloaded HTMLs in a content storage. The HTML downloader downloads a web page from the Internet URL. In this case, in order for the HTML downloader to download a web page and store the downloaded web page in a URL storage, the DNS resolver converts a URL to an IP address, and the HTML downloader uses the DNS resolver to find out the IP address corresponding to the URL, downloads a web page, checks “Content Seen?” whether it is the ‘body content’ of a page that has already been visited, and stores it in the content storage, and then checks “URL Seen?” whether it is the URL that has already been visited, and since visiting the URL that has already been visited at this time will cause an infinite loop, the URL filter removes the URLs that have already been visited and duplicate URLs and passes them back to the URL frontier to continuously search and repeat this process.

The web crawler manages its crawling status with (1) a URL to download, and (2) a downloaded URL. In particular, web pages should not be collected and stored indiscriminately, and there are html pages that can be collected by the rules written in robot.txt, and html pages that cannot be collected and are prohibited from unauthorized redistribution according to the copyright of overseas media articles. For reference, Google defines robots.txt as a file that instructs search engine crawlers which pages or files they can or cannot request from a site. The file defines the paths that the crawler can request or that it should not crawl. In addition, various content items such as how many seconds intervals to send requests may be written in robots.txt.

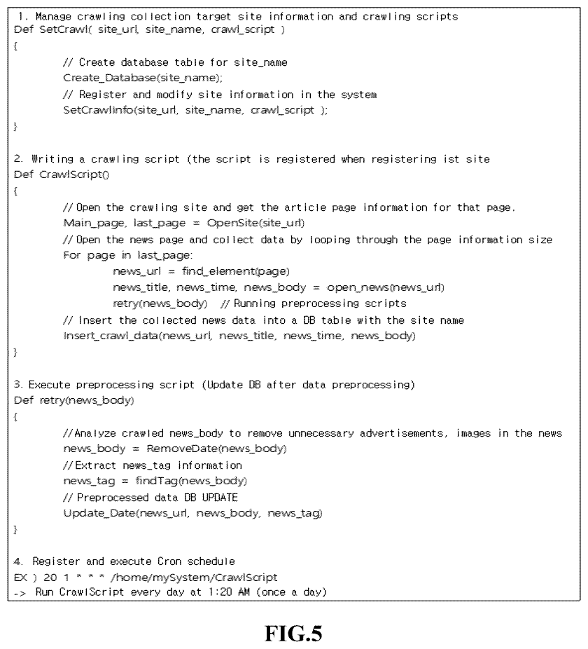

FIG. 5 shows a crawling module written in a Python script format.

The crawling module 100 includes four components: an overseas media collection target site URL, a crawling script, a preprocessing script, and collection cycle management. When a URL of an overseas media collection target site is registered, the system operates a crawling module and a crawling database. Then, when a crawling script for an overseas media collection target site is registered with the system, it is executed by a preset collection cycle, and a result thereof is stored in a database of the server of the web crawling system. Then, a preprocessing script is run to process the stored data, and finally stored in the DB. Collection cycle management may utilize a service such as Cron provided by the operating system.

The issue area definition and update module 200 performs, when various types of issues such as an infectious disease, a war, and a disaster occur, generation and upgrade of an issue area, and keyword addition and upgrade, wherein a keyword is used to define an issue area, and the keyword defining the issue area includes an issue identification keyword, a field-of-interest identification keyword, and a field-of-interest change keyword.

Table 1 illustrates examples of types of issues that can affect the global value chain (GVC). Various types of issues may occur, such as an infectious disease, a war, and a disaster. The definition of the issue area is carried out by using a keyword. Table 2 defines the composition of issue definition keywords, including an issue identification keyword, a field-of-interest identification keyword, and a field-of-interest change keyword. Table 3 presents the evolution of a term corresponding to an issue identification keyword, using an infectious disease as an example. Table 4 shows an example of a process of generating a new issue area.

The issue area definition and update module 200 performs generation and upgrade of an issue area in Table 2, and keyword addition and upgrade.

The item-of-interest and region-of interest input module 300 selects an issue area with GVC, and receives an item of interest and a region of interest.

FIG. 3 shows a screen for selecting an issue area and entering an item-of-interest and a region-of-interest. Companies or organizations that manage GVC may utilize it to select items and regions necessary for management. If the client does not enter items or regions of interest, then it is assumed that the client wants to obtain general information associated with GVC and provide general GVC information.

The GVC incident monitoring and trend analysis module 400 is implemented in a manner of calculating a number of issue-related keywords and expressing figures in a graph, and FIG. 3 shows an example of a screen for monitoring GVC incidents and analyzing trends.

The issue article discovery module 500 performs a role of finding issue articles containing a step-by-step keyword defined in Table 2. The step-by-step keyword includes an issue identification keyword, a field-of-interest identification keyword, and a field-of-interest change keyword, and articles including the issue identification keyword are extracted in a first step, and articles including the field-of-interest identification keyword are extracted from the articles selected in the first step in a second step. Articles including the field-of-interest change keyword are extracted from the articles extracted in the first and second steps in a third step. It is up to the client to determine whether to finish extracting articles in a first step, or proceed to a second or third step.

The issue article information extraction and summary module 600 carries out a procedure of extracting information for GVC and summarization from issue articles discovered by the issue article discovery module 500. A procedure of extracting information for GVC from the discovered issue articles is developed into key information (issue-centered information) that clients directly need and reference information (economic outlook information, market trend information, supply chain trend information) that is good for the clients to know (see Table 6).

It is up to the client to determine whether to check only the key information of the issue articles or to select reference information as well. Key information, which is “issue-centered information,” refers to information composed of sentences containing an issue, an item of interest, and a region of interest that clients are looking for. Reference information, which is information on economic trends, supply chain trends, and market trends, when provided to clients, is information that helps the clients make decisions. Key information and reference information are extracted from issue articles and thus are all in sentence form.

Table 2 is a table showing “Examples of Issue Areas.”

Table 3 is a table describing “Composition of Keywords Defining Issue Areas.”

A keyword defining an issue area includes an issue identification keyword, a field-of-interest identification keyword, and an interest area change keyword.

Table 4 is a table showing “Examples of Evolution of Term.”

Table 5 is a table showing “Examples of Issue Area Generation Process.”

TABLE 2

| Issue Area Name | Description |
|---|---|
| Infectious Disease | Infectious disease incident affecting GVC, such as |
| | COVID |
| War | War incident affecting GVC |
| Disaster | Disaster incident affecting GVC such an earthquake, |
| | typhoon, wildfire, drought, and environment |

TABLE 3

| Keyword Defining Issue Area | Description |
|---|---|
| Issue Identification Keyword | Noun referring to an issue |
| Field-of-interest | A noun referring to a field of interest |
| Identification Keyword | in connection with an issue |
| Field-of-interest Change | A word referring to a change in a field- |
| Keyword | of-interest |

TABLE 4

| Issue Article | | |
|---|---|---|
| Keyword | Date of Occurence | Infectious Disease |
| Development of | Dec. 31, 2019 | Coronavirus, Coronavirus |
| Term | | Pandemic |
| | Feb. 19, 2020 | COVID-19 |
| | Feb. 27, 2020 | COVID-19 Pandemic |
| | Mar. 23, 2020 | Coronavirus-19 |
| | Jun. 6, 2021 | Delta Variants |
| | Nov. 30, 2021 | Omicron Variants |

TABLE 5

| Issue Area | | | Occurred Issue |
|---|---|---|---|
| Generation Process | Date of Occurrence | Occurred Incident | Area |
| Process of | Dec. 31, 2019 | COVID Pandemic outbreak | Infectious |
| Occurence of | | | diseases |
| Incident | Mar. 23, 2021 | “Ever Given” aground in | Logistics |
| | | Suez Canal | accident |
| | Feb. 23, 2022 | Russian invasion of | War |
| | | Ukraine | |

Table 6 defines a structure of a sentence to divide the sentence into a complete sentence, an incomplete sentence, and a general sentence. The grammar and parts of speech for constructing a sentence are developed in the form of an index in Table 8. In a news list/article, multiple English sentences making up an issue article have a subject, a verb, an indirect object/direct object, an adjective, a noun, an adverb, and a complement. The type of phrase includes a noun phrase, an adjective phrase, and an adverbial phrase, and there are a noun clause, an adjective clause, and an adverbial clause. The sentence combination framework is used to summarize the extracted issue articles. The sentence combination framework is written in English and may be additionally applied to Korean issue articles.

Table 6 is a table describing a method of “Structure of Sentence”.

Table 7 is a table describing “Type of Information Extracted Based on Sentence Structure.”

Table 8 is a table summarizing “Types of Parts of Speech in Language of Issue Articles in Terms of GVC Economics”. The type of an index that constitutes the grammar of the key word combination algorithm may include a market player, a market role, a market increase and decrease, a supply chain, a supply chain status change, a number and size, a ratio, a currency indicator, a date and time, and an item may be additionally set as needed.

TABLE 6

| Item of Sentence | |
|---|---|
| Structure | How Sentences Are Structured - Description |
| Complete | Information composed of a complete type sentence containing “a |
| Sentence | market player or market role, an increase or decrease in the market, |
| | an item, a place name” |
| Incomplete | Information composed of a sentence that is missing an item or name |
| Sentence | from a complete main sentence |
| General | Sentence-type information with high information value, including |
| Sentence | key figures but without any item or place name in a complete |
| | sentence |

TABLE 7

| | | Type of Information Extracted Based on Sentence |
|---|---|---|
| Item | | Structure - Description |
| Key | Issue-centered | Information to be searched for “an issue, an item of |
| Information | Information | interest, a region of interest.” |
| | | Information is composed of complete or incomplete |
| | | sentences |
| | | ※ If there is insufficient information, it will appear |
| | | an an incomplete sentence. |
| Reference | Economic | A sentence containing “economic indicators, figures” |
| Information | Outlook | A complete sentence, an incomplete sentence, and a |
| | Information | regular sentence are all allowed. |
| | Supply Chain | A sentence containing a “supply chain status change” |
| | Trend | among a complete sentence, an incomplete sentence, and |
| | Information | a general sentence |
| | Market Trend | A sentence that allows a client to check overall market |
| | Information | situation information |
| | | Composed of a general sentence |

TABLE 8

| Parts of Speech of Language | | Types of Parts of Speech in Language of Issue |
|---|---|---|
| | | Article in Terms of GVC Economics - Description |
| Market Player | | A player that leads the market situation, such |
| | | as demand, production, and supply |
| Market Play | | Words that express the actions of market players |
| Increase or Decrease In the | | A word that describes a quantitative change in |
| Market | | an item or currency in a market. |
| Supply Chain | | A word to check the supply chain |
| Supply Chain Status Change | | A word that describe a change in the state of a |
| | | supply chain |
| Size | Number | A numerical value and a word expressing the |
| | | numerical value |
| | Amount | A word expressing the amount |
| | Ratio | A word expressing a ratio such as a multiple, a |
| | | fraction, and a percentage |
| | Currency | A country's currency and money supply |
| | Economic Indicators | A word the expresses economic trends in figures |

| | |
|---|---|
| Date and Time (Date) | A word expressing a date, a time, and a date and |
| | time |

Table 9 is a table describing a composition and example of “Korean Sentence Combination Template.”

Table 10 is a table describing a composition and example of “Sentence Combination Framework” in English

TABLE 9

| Item | Korean Sentence Combination Framework - Description |
|---|---|
| Sentence | At “date and time”, for “item” in “region”, “market player” |
| Combination | “increase or decrease is the market” by “size” due to the “issue.” |
| Examples of | Region: LA area, USA, Item: Electric vehicle, Issue: Corona |
| Keywords | outbreak, Market player: Production, Size: Half, Market |
| Constituting | increase/decrease: Decrease. |
| Combination | |
| Example of | “Production” of “electric vehicles” in the “LA region, USA” is |
| Combined Summary | “cut” by “half” due to the “coronavirus outbreak.” |
| Sentence | → In LA region, USA, electric vehicle production in cut in half |
| | due to the outbreak of coronavirus. |

TABLE 10

| item | Sentence Combination Framework - Description |
|---|---|
| Combination | By the “issue”, “region's” “item”, “market player”, “increase or |
| Framework | decrease in the market” by “size” in “date” |
| Example of Key | issue: COVID outbreak, region: America LA, Item: EVs, market player: |
| words | manufacturer, increase or decrease in the market: decrease, size: half, |
| | date: August |
| Combined | By the COVID outbreak, America LA′ EVs manufacturer decrease by half |
| Sentence | in August |

Tables 11 and 12 are tables showing “Example of Issue Item, Issue Article Discovery, Key Sentence Extraction, and Summary” (Table 11: Issue Item-Infectious Disease, Table 12: Issue Item —Electric Vehicle Batteries).

TABLE 11

| Overseas | | | | | |
|---|---|---|---|---|---|
| media site | Date | Title | Key sentence | Combination | Summary |
| Reuters | Oct. | UAW's record | ‘This is a set of negotiations, | market player | The labor |
| | 30, | deal could | historically, where gains made in | → labor | market remain |
| | 2023 | boost others' | Detroit would be viewed and | market | tight by |
| | | wages as | adapted by many other | increase or | unemployment |
| | | labor notches | industries across the economy,’ | decrease in | at 3.8% |
| | | another victory | said Harley Shaiken, labor | the market → | |
| | | | professor at the University of | remain tight | |
| | | | California, Berkley. Union worker | size → | |
| | | | compensation has finally caught | unemployment | |
| | | | up to non-union wage increases | at 3.8% | |
| | | | dating from the COVID-19 | | |
| | | | pandemic, according to U.S. | | |
| | | | federal data, as the labor market | | |
| | | | has remained tight with | | |
| | | | unemployment at just 3.8%. | | |

TABLE 12

| Overseas | | | | | |
|---|---|---|---|---|---|
| media site | Date | Title | Key sentence | Combination | Summary |
| Reuters | Oct. | Tesla's Musk | The company, which built its | issue → | By the increase |
| | 19, | raises | first Cybertruck in July, had in | increase in | in battery raw |
| | 2023 | Cybertruck | 2019 expected to price the | battery raw | material prices, |
| | | production | vehicle under $40,000, but | material prices | electric vehicle |
| | | concerns, | electric vehicle prices have since | market play → | prices rise |
| | | reveals | risen due to an increase in | electric vehicle | |
| | | delivery date | battery raw material prices. | prices | |
| | | | | increase or | |
| | | | | decrease in | |
| | | | | the market → | |
| | | | | rise | |

A web crawler system that crawls Internet articles and provides a summary service of issue articles affecting the global value chain (GVC) crawls English issue articles from major global media including CNN USA, NYT (New York Times), WSJ (Wall Street Journal), Reuters UK and the like on the Internet to classify news by article title and store the article list/articles in a server DB, and then performs sentence classification (SC, multiple sentence sets) on overseas media issue articles, and then selects sentences containing key words of an item of interest from a sentence set including multiple sentences of English issue articles by utilizing a S/W engine to analyze global economic trends in overseas media issue articles and predict risks, selects sentences containing the key words of the item of interest (positive/negative) by natural language inference (NLI) for the remaining sentences, identifies the beginnings and ends of sentences using tokens in each of the selected sentences and extracts sentences, and extracts key words in each sentence, and combines words extracted again according to English grammar, sentence structure, and word order, on the basis of the title of the issue article using a segmentation technique of a language model (LM) of natural language processing (NLP) into phrases/clauses/words of English sentences and a key word combination algorithm of segmentation techniques to generate summary sentences and provide a summary of issue articles of overseas media that affect the global supply chain and global value chain (GVC).

The overseas issue article summary web crawler system may crawl English issue articles of overseas media outlets on the Internet and store them in a server DB to detect and preemptively respond to risks in the global supply chain or global value chain (GVC) for the issue from an economic perspective, and then monitor issue articles containing various incidents occurring in the global value chain (GVC) and global supply chain required by clients in real time, extract key word information from issue articles of overseas media, summarize the issue articles to provide a framework to provide a service. Furthermore, this framework is configured to provide both a cloud computing issue article summary service and an on-premise service. In a current situation where incidents and accidents are frequent in each country around the world and have a significant impact on the global value chain (GVC) and global supply chain, it will be a very useful solution for economic organizations that need to predict risks in the global value chain (GVC), provide economic outlook of issues to companies and customers who need to respond preemptively, and make decisions.

Embodiments according to the present disclosure may be implemented in the form of program commands that can be executed through various computer elements, and recorded on a computer-readable recording medium. The computer-readable recording medium may include program instructions, data files, data structures, and the like individually or in combination thereof. The computer-readable recording medium may include a hardware device configured to store and execute program instructions on magnetic media such as storages, servers, hard disks, floppy disks and magnetic tapes, optical media such as CD-ROMs and DVDs, magneto-optical media such as floptical disks, and storage media such as ROMs, RAMS, flash memories, storages, and the like. Examples of program instructions may include those produced by a compiler, and high-level language codes that can be executed by a computer using an interpreter, as well as machine codes. The hardware device may be configured to operate as one or more software modules in order to perform the operation of the present disclosure.

The method of the present disclosure may be implemented as a program and stored in a recording medium (CD-ROM, RAM, ROM, memory card, hard disk, magneto-optical disk, storage device, etc.) in a form that can be read using computer software.

As described above, although the present disclosure has been described with reference to specific embodiments, the present disclosure is not limited to the same configuration and operation as the specific embodiments to illustrate the technical concept as described above, and may be implemented by various modifications without departing from the technical concept and scope of the present disclosure, and the scope of the present disclosure should be determined by the claims described below.

What is claimed is:

1. A web crawler system that crawls and collects Internet articles and provides a summary service of issue articles affecting the global value chain, the system comprising:
a user terminal provided with a web agent that crawls and crawls English issue articles of overseas media, searches keywords, and displays a summary of overseas media issue articles; and
an overseas issue article summary web crawler system that crawls English issue articles of the overseas media by the web agent to store multiple news article lists/articles classified by article titles in a DB, and then searches for keywords, performs sentence classification (SC) on the issue articles, selects sentences containing key words of an item of interest in the issue articles, extracts words from each sentence, and provides a summary of overseas media issue articles that affect the global value chain (GVC) using a key word combination algorithm of segmentation techniques for each sentence according to English grammar, sentence format, and word order.

2. The system of claim 1, wherein the user terminal uses a computer, a laptop computer, or a smartphone/tablet PC.

3. The system of claim 2, wherein the web agent provided in the user terminal is used as a language agent, the web agent comprising:
a crawling module that crawls issue articles of the overseas media outlets, classifies news according to article titles, and stores an article list/articles in a server DB of the overseas issue article summary web crawler system;
a keyword search module that searches for keywords in English issue articles of overseas media outlets; and
an issue article summary display module that performs sentence classification (SC, multiple sentence sets) on English issue articles from overseas media outlets on the server, and then extracts sentences by identifying the beginning and end of each sentence using tokens, selects sentences containing key words of an item of interest with priorities, extracts words constructing each sentence, and combines the extracted words again to generate and store a summary sentence using a segmentation technique and a key word combination algorithm based on English grammar, sentence format, and word order on the basis of the titles of overseas media issue articles, and provides a summary of issue articles transmitted from the server.

4. The system of claim 1, wherein the keyword is a keyword defining an issue area, the keyword comprising an issue identification keyword, a field-of-interest identification keyword, and a field-of-interest change keyword.

5. The system of claim 1, wherein the overseas issue article summary web crawler system uses a BERT algorithm or GPT-4 algorithm is used to extract a summary of the English issue articles of the overseas media outlets, and a key word combination algorithm that utilizes a segmentation technique of phrases/clauses/words of English sentences after sentence classification (SC) of the issue articles.

6. The system of claim 1, wherein the overseas issue article summary web crawler system comprises:
a web server and a database;
an issue area definition and update module that performs, when various types of issues such as an infectious disease, a war, and a disaster occur, generation and upgrade of an issue area, and keyword addition and upgrade, wherein a keyword is used for defining an issue area, and the keyword defining the issue area comprises an issue identification keyword, a field-of-interest identification keyword, and a field-of-interest change keyword;
an item-of-interest and region-of interest input module that selects an issue area with the global value chain (GVC), and receives an item of interest and a region of interest;
a GVC incident monitoring and trend analysis module that is implemented by calculating a number of issue-related keywords and expressing figures in a graph, and monitors a GVC incident, analyzes a trend, and displays them on a screen of the user terminal;
an issue article discovery module that performs a role of finding issue articles containing a step-by-step keyword; and
an issue article information extraction and summary module that extracts GVC information from the issue articles discovered by the issue article discovery module, summarizes the extracted issue articles, and specifically, performs sentence classification (SC, multiple sentence sets) constructing English issue articles of overseas media outlets using a BERT or GPT-4 algorithm on the server, and then identifies the beginnings and ends of sentences using tokens in each sentence in a sentence set including multiple sentences of English issue articles and extracts sentences, selects sentences containing key words of an item of interest with priorities, selects sentences related to the key words of the item of interest (positive/negative) by natural language inference (NLI) for the remaining sentences, extracts words from each sentence of the selected sentences, and combines the extracted words again, extracts the words again and generates a summary of issue articles and stores it in the server DB using a segmentation technique of phrases/clauses/words of English sentences based on English grammar, sentence format, and word order centered on titles of overseas media issue articles and a key word combination algorithm, and then provides a summary of the overseas media issue articles transmitted from the server.

7. The system of claim 6, wherein the step-by-step keyword comprises an issue identification keyword, a field-of-interest identification keyword, and a field-of-interest change keyword, and articles including an issue identification keyword are extracted in a first step, articles including a field-of-interest identification keyword are extracted from the articles selected in the first step in a second step, and articles including a field-of-interest change keyword are extracted from the articles extracted in the first and second steps in a third step.

8. The system of claim 6, wherein the issue article information extraction and summary module carries out a procedure of extracting information for GVC from issue articles discovered by the issue article discovery module and summarizing the extracted issue articles, and the procedure of extracting information for GVC from the discovered issue articles extracts key information that clients directly need and reference information that helps the clients make decisions from the issue articles,
wherein the key information is issue-centered information, and
wherein the reference information comprises information on economic trends, supply chain trends, and market trends.

9. The system of claim 1, wherein the type of an index that constitutes the grammar of the key word combination algorithm comprises a market player, a market role, a market increase and decrease, a supply chain, a supply chain status change, a number and size, a ratio, a currency, an economic indicator, a date and time, and an item may be additionally set as needed.

10. The system of claim 3, wherein the overseas issue article summary web crawler system further comprises a chat server, and
wherein the web agent further comprises a chat module that transmits and receives chat data between journalists and site operators through the chat server.
